(19) United States
(12) Patent Application Publication
(10) Pub. No.: US 2005/0037243 A1
(43) Pub. Date: Feb. 17, 2005

(54) Method for operating a PEM fuel cell system, and associated PEM fuel cell system

(75) Inventors: Olaf Dubel, Isenbuttel (DE); Gert Hinsenkamp, Vordorf (DE); Jan-Kasper Kuipers, Wolfsburg (DE); Christoph Maume, Braunschweig (DE); Walter Preidel, Erlangen (DE); Walter Stuhler, Hirschaid (DE); Alfred Weiss, Forchheim (DE)

Correspondence Address: LERNER AND GREENBERG, PA, P O BOX 2480, HOLLYWOOD, FL, 33022-2480, US

(73) Assignee: Siemens Aktiengesellschaft

(21) Appl. No.: 10/868,726

(22) Filed: Jun. 14, 2004

Related U.S. Application Data
(63) Continuation of application No. PCT/DE02/04554, filed on Dec. 12, 2002.

(30) Foreign Application Priority Data
Dec. 14, 2001 (DE) 101 61 622.8

(51) Int. Cl. H01M 8/04; H01M 8/10

(52) U.S. Cl. 429/13; 429/30; 429/34; 429/25; 429/26

(57) ABSTRACT

The air supplied to a fuel cell module is pumped with a compressor that has a moisturizing function in order to provide sufficiently moisturized oxidant. The compressor operates at very low pressure and the moisturization corresponds approximately to the dew point at the cooling water outlet temperature. If adequate moisturizing of the oxidant is no longer occurring at the defined low pressure, the input pressure is increased and the oxidant output is choked in a regulated manner. A corresponding fuel cell assembly with a polymer electrolyte membrane, i.e., a PEM fuel cell system includes the corresponding pump compressor and a controlled throttle valve at the exit side.

### CROSS-REFERENCE TO RELATED APPLICATION

This application is a continuation, under 35 U.S.C. § 120, of copending international application No. PCT/DE02/04554, filed Dec. 12, 2002, which designated the United States; this application also claims the priority, under 35 U.S.C. § 119, of German patent application No. 101 61 622.8, filed Dec. 14, 2001; the prior applications are herewith incorporated by reference in their entirety.

### BACKGROUND OF THE INVENTION

Field of the Invention

The invention relates to a method of operating a PEM fuel cell system which works with hydrogen as fuel gas and with air as oxidizing agent, in which a sufficient supply of air is required for a rapid load change and in which the air supplied has to be humidified. The invention further relates to an associated fuel cell system having at least one fuel cell module comprising PEM fuel cells, which are supplied, as process gases, with hydrogen on the one hand and with air on the other hand, having means for supplying air and for humidifying the air supplied, which comprise a compressor for compressing the air and a control device for managing the fuel cell operating process.

So-called air PEM fuel cell systems, which are operated with hydrogen and air, including their process program and the associated functioning are well known from the prior art: in each case one fuel cell module forming the core piece of the system is formed from a multiplicity of fuel cells which are stacked on top of one another and electrically connected in series. Those of skill in the art refer to such an assembly as a fuel cell stack or just “stack” for short. A plurality of fuel cell modules can be electrically connected up.

In the case of the latter PEM fuel cell modules operated with air, a sufficient supply of air is required for a stable operating mode which is insensitive to rapid load changes. The supply of air is also at the same time intended to ensure sufficient humidification of the air, with the pressure dew point of the air approximately corresponding to the cooling-water outlet temperature or a higher value at the respective pressures and temperatures of the fuel cell stack. This is most important particularly when the cooling of the fuel cell stack is not optimal.

If a fuel cell system is supplied with air by a compressor which is unable to provide sufficient humidification of air at the inherently desirable low pressures, for example 1.5 bar (absolute) at the stack exit, it is necessary to take suitable measures to remedy this. One technical solution to the problem consists in increasing the entry pressure at the stack. This makes the humidification of the air simpler, i.e., less energy-consuming, on account of the shift in the water-vapor partial pressure curve. In many cases, it is only in this way that it is possible to achieve the humidification at all. Increasing the stack entry pressure purely by increasing the compressor power, however, is only possible to a limited extent, and in many cases uneconomical, in particular on account of inadequate dynamics when adjusting the compressor power required for rapid load changes.

### SUMMARY OF THE INVENTION

It is accordingly an object of the invention to provide a method of operating a PEM fuel cell system and such a system which overcome the above-mentioned disadvantages of the heretofore-known devices and methods of this general type and which provides for suitable measures for humidifying the operating air of fuel cell systems and also provides an apparatus that is suitable for doing so.

With the foregoing and other objects in view there is provided, in accordance with the invention, a method of operating a PEM fuel cell system operating with hydrogen (fuel gas) and air (oxidizing agent), the method which comprises:
providing a compressor for selectively feeding sufficient quantities of air required for a rapid load change and humidifying the air, and operating the compressor at lowest possible pressures;
setting a humidification of the air to correspond to a pressure dew point at a cooling-water outlet temperature;
upon determining that the humidification of the air is no longer sufficient at a predetermined low pressure, increasing an entry pressure to achieve the humidification of the air by a shift in a water-vapor partial pressure curve;
and controlled throttling of the air exit stream.

In accordance with an added feature of the invention, the air exit stream is automatically throttled by associated actuating electronics that drive a throttle valve. Preferably, the actuating electronics are driven within a central fuel cell operating management.

In accordance with another feature of the invention, the shift in the water-vapor partial pressure curve is effected to enable the humidification of the air with a lower energy consumption than without the throttling of the air exit stream. Preferably, the shift in the water-vapor partial pressure curve is effected to enable smaller quantities of water to be used for sufficient humidification of the air than without the shift in the water-vapor partial pressure curve.

With the above and other objects in view there is also provided, in accordance with the invention, a PEM fuel cell system, comprising:
at least one fuel cell module comprising PEM fuel cells;
a first process gas inlet for feeding hydrogen to the fuel cells;
a second process gas inlet for feeding air to the fuel cells;
an outlet side, a throttling member disposed at the outlet side, and actuating electronics connected to the throttling member for adjusting a position of the throttling member;
a device for supplying air to the second process gas inlet and for humidifying the air, the device including a compressor for compressing the air; and
a control device for managing a fuel cell operating process, wherein the position of the throttling member effecting a pressure raising a compression power of the air compressor to a pressure level required for sufficient humidification of the air, with the actuating electronics serving to correct the position of the throttling member.

In accordance with another feature of the invention, the actuating electronics and the throttling member are connected via a bidirectional connection. Similarly, the actuating electronics and the control device for managing the fuel cell operating process are connected via a bidirectional connection.

In accordance with again an added feature of the invention, the control device for managing the fuel cell operating process includes means for recording actual values of operating variables of the fuel cell system, for example, the the air entry pressure for the fuel cell module.

In accordance with again another feature of the invention, the air compressor is a screw-type compressor. In accordance with again a further feature of the invention, the throttling member is a controllable throttle valve.

In accordance with an a particularly preferred embodiment of the fuel cell system there is provided a heat exchanger with cooling medium communicating with the fuel cell module.

In accordance with a further feature of the invention, the system also includes a water separator at the outlet side, and an electrically controllable valve for discharging excess water communicating with the water separator. Preferably, the the water separator includes a level indicator.

In the method according to the invention, the increase in the entry pressure at the stack for higher air compressor powers in the compressor is realized by throttling the outgoing air from the stack. Since at low air outputs in the medium or low output range constant throttling is unsuitable for the generation of a sufficiently high pressure, which requires the compressor to have a power which is sufficient to evaporate the water, the throttle valve is also controlled.

This latter feature means that, overall, at maximum power constant throttling already sets an optimum operating pressure. Since the pressures are too low in the part-load range for the compressor to be able to apply enough power to evaporate a sufficient quantity of water for humidification, the throttle valve and the compressor power are also adjusted.

In the apparatus according to the invention, the compressor, which is inherently known per se, is already working at the lowest possible pressures, with the humidification of the air under normal circumstances corresponding to the pressure dew point at the cooling-water outlet temperature. However, if there is no longer sufficient humidification of the air at the predetermined low pressure, the entry pressure at the stack is increased in such a way that the humidification of the air is achieved by shifting the water-vapor partial pressure curve. The throttle valve with actuating electronics and the control device which is present for fuel cell operating management are provided with a view to realizing these measures, with the throttle valve setting determining the required pressure and the compression power and the compressor automatically adjusting the electrical power for the required delivery of air. The result is a pressure which is required for sufficient humidification of the air.

Therefore, the invention uses a simple concept to advantageously humidify the air by increasing the entry pressure of the air at the stack. As a result, the compressor power is increased, and in this way more water is evaporated, since it is known that the water-vapor partial pressure curve is shifted as a result of an increase in pressure. Therefore, less water is required for sufficient humidification than without any shift in the water-vapor partial pressure curve. The invention therefore advantageously produces two effects—namely the reduction in the energy costs for humidification, on the one hand, and the reduction in the water quantities, on the other hand—with the combination of these measures surprisingly allowing sufficient humidification of the water for supplying air to the fuel cells.

Other features which are considered as characteristic for the invention are set forth in the appended claims.

Although the invention is illustrated and described herein as embodied in a method for operating a pem fuel cell system, and associated PEM fuel cell system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of a fuel cell module with means for setting the pressure; and

FIG. 2 is a schematic view showing the pressure control for a single fuel cell.

### DESCRIPTION OF THE PREFERRED EMBODIMENTS

The operation of fuel cell systems requires the provision of a sufficient quantity of oxidizing agent, generally atmospheric oxygen, on the cathode side. The air mass flow required for this purpose is usually aspirated in from the environment and brought to the stack inlet state by way of a pressure-increasing installation, e.g. a compressor or a fan. For process engineering reasons, the air mass flow often has to have a defined moisture saturation (e.g., 100% relative humidity), which can be characterized by way of the pressure dew point of the air mass flow at the cathode-side stack inlet.

The air-wetted inner surfaces of the fuel cell are generally at a temperature which differs in both space and time from the air mass flow or its pressure dew point. The temperatures of the inner surfaces of the fuel cell are crucially determined by the cooling-water inlet temperature and by the generation of heat in the fuel cell, which leads, as a function of the coolant mass flow, to a coolant outlet temperature which is increased with respect to the state. Therefore, both temperatures are crucially dependent on the ambient temperature or, if the fuel cell system is used in a vehicle, on the driving speed of the latter and if appropriate the forced ventilation that is employed in the specific case.

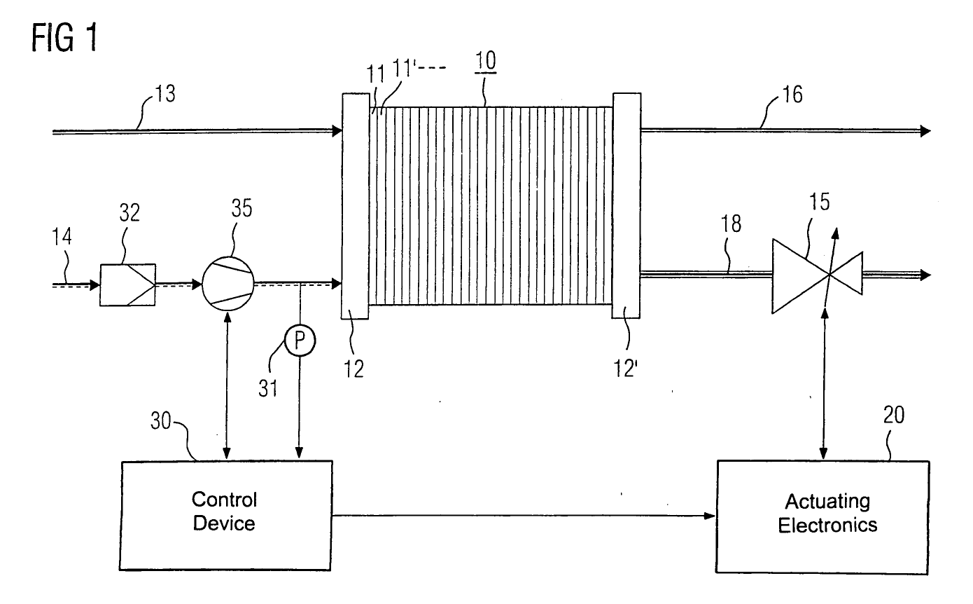

Referring now to the figures of the drawing in detail and first, particularly, to FIG. 1 thereof, there is shown a fuel cell module 10 that forms a part of a fuel cell system that is operated with hydrogen as the fuel gas, on the one hand, and with air as the oxidizing agent, on the other hand. In detail, 11, 11′, . . . denote individual PEM fuel cells, which form a fuel cell stack, also referred to simply as a “stack” for short. The fuel cell stack is delimited by solid end plates 12 and 12′, which are also responsible for gas routing. The acronym PEM represents “polymer electrolyte membrane” or “proton exchange membrane.”

In FIG. 1, the fuel gas is supplied via a fuel gas inlet 13 and an oxidizing agent is supplied via an oxidizing agent inlet 14. Hydrogen as fuel gas is supplied from a separate hydrogen tank, or if appropriate also from a reformer. Air as oxidizing agent is present in the environment. A quantity of oxidizing agent which is sufficient for the fuel cell operating process is provided from the ambient air via the line 14, for which purpose a filter 32, indicated symbolically in the figure, and a downstream compressor 35 are present. In a preferred embodiment, the compressor 35 is a screw-type compressor, which has been tried and tested in the prior art.

Specifically, a screw-type compressor with liquid injection is known from German published patent application DE 195 43 879 A1. That compressor has a good level of efficiency and ensures the injection of liquid using simple means.

At the exit of the fuel cell stack 10, residual gas is discharged via a residual gas line 16, and remaining air is discharged via an air line 18. In the air line 18 there is a throttle valve 15 as a controllable valve. The throttle valve 15 is bidirectionally connected to actuating electronics 20, which in turn are bidirectionally connected to a control device 30 for the fuel cell operating process. The pressure at the entry to the fuel cell stack 10 is input to the control device 30 as an actual value, for which purpose there is a pressure gauge 31.

Therefore, the following functionality results: under normal circumstances, the stack 10 is supplied with humidified air by the liquid screw-type compressor 35. If the compressor 35 cannot sufficiently humidify the air at the inherently desirable low pressures, for example 1.5 bar (absolute) at the entry of the stack 10, the entry pressure in increased. The resultant shift in the water-vapor partial pressure curve in principal makes it easier, i.e. less energy-consuming, and if appropriate even makes it possible for the first time, to effect the required humidification of the compressor air.

The increase in the entry pressure originates from the throttling of the outgoing air from the stack 10 via the controllable throttle valve 15 in the air exit line 18. This increases the compression power of the compressor 35 up to a level at which the necessary pressure required for sufficient humidification of the air is achieved.

In accordance with FIG. 1, the control mechanism is performed by the central fuel cell control 30, since in addition to the position of the throttle valve 15, the electrical power of the compressor 35 is also adapted automatically. The specific control by means of the actuating electronics 20 serves to correct the position of the throttle valve 15.

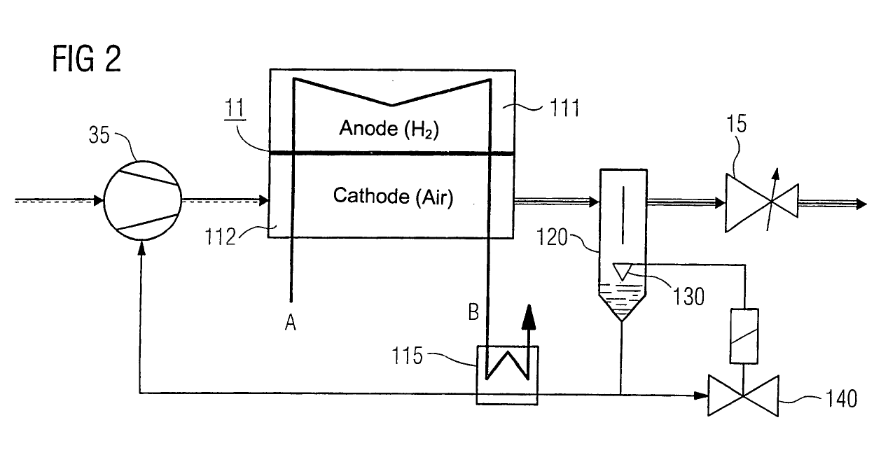

FIG. 2 illustrates a single fuel cell 11 from FIG. 1, which is formed from an anode 111 and a cathode 112 with an electrolyte arranged between them. Once again, the oxidizing agent used is air. There is a fluid cooling medium.

The heat which is transferred into the coolant is used in FIG. 2 to preheat the injection water mass flow into the compressor. This may be effected, for example, via a heat exchanger 115 or alternatively by the direct use of at least one part-stream of the fuel cell cooling medium as injection fluid.

If the temperature of the internal, air-wetted surfaces of the fuel cell 11 is higher than the pressure dew point of the air mass flow, the air mass flow is overheated, i.e. the relative humidity drops. This is considered a disadvantageous or potentially harmful state for operation of the fuel cell 11, since it promotes drying-out of the internal surfaces, which can lead to irreversible damage to the fuel cell 11. Conversely, surface temperatures below the pressure dew point lead to partial condensation of the moisture contained in the air. The condensate which is formed prevents the atmospheric oxygen from gaining access to the reactive surfaces and therefore reduces the power of the fuel cell 11, which is likewise undesirable.

Therefore, the purpose of optimized operation of the fuel cell 11 is to set the minimum possible temperature difference between inner air-wetted surfaces and the pressure dew point of the air mass flow for all operating states. This temperature leveling must be sufficiently rapid to be able to follow the dynamic load changes in the fuel cell.

In FIG. 2, the pressure at the cathode-side stack inlet is once again used as a suitable control variable and can be set, for example, by way of a suitable actuation of the pressure-increasing device, or alternatively by way of a variably actuable throttling member in the cathode-side flow path downstream of the fuel cell. The throttling member is once again advantageously configured as a controllable throttle valve 15 or as an expansion machine, which can be used to recover some of the energy contained in the cathode exhaust gas as mechanical energy. The arrangement is completed by a water separator 120, which is arranged downstream of the fuel cell 11 and upstream and/or downstream of the throttling member 15. In the water separator 120, both the product water formed in the fuel cell 11 and also any condensate fractions contained in the airstream are separated out and fed to the internal water circuit of the overall fuel cell system. The water separator 120 advantageously includes a level control 130, which releases excess water via an electrically controllable valve 140 to the environment or other parts of the system which are not shown in FIG. 2.

Changing the cathode-side stack inlet pressure has three main effects on the properties of the air mass flow at the stack inlet. These are, in detail:
An increase in the pressure leads to a reduction in the specific volume of the air mass flow, which at the same absolute moisture content leads to an increase in the relative humidity or to a drop in the pressure dew point.
An increase in the pressure requires an increased compression power, which is available in the air as an increased quantity of heat of evaporation. It is therefore possible to evaporate more water, which likewise contributes to increasing the atmospheric humidity or to lowering the dew point.
An increase in the pressure with a constant air mass flow, in the configuration of components shown by way of example, leads to an increase in the injection-water mass flow. This leads to increased availability of the energy contained in the injection water and its internal surface area, increased by the mass flow, for the application of evaporation enthalpy. This likewise results in an increase in the atmospheric humidity or a reduction in the pressure dew point.

It is therefore possible, by changing the said pressure, to vary the pressure dew point of the air at the stack inlet within wide limits, in order to match it as fully as possible to the inlet or outlet temperatures of the cooling medium for the fuel cell.

The change in the pressure can be influenced sufficiently quickly by correspondingly rapid setting of the control section comprising compressor 35 or throttling member 150 to ensure that the temperature difference between pressure dew point and internal surface areas is minimized even during dynamic operation of the fuel cell.

In accordance with FIG. 1, the fuel cell control is used to automatically control the pressure by way of a suitable control strategy, which is based on a targeted measurement of the temperature difference between pressure dew point at the stack inlet and the inlet and/or outlet temperature of the cooling medium. The control strategy may, in particular, also take into account time-based gradients in the temperature difference.

1. A method of operating a PEM fuel cell system operating with hydrogen and air, the method which comprises:
providing a compressor for selectively feeding sufficient quantities of air required for a rapid load change and humidifying the air, and operating the compressor at lowest possible pressures;
setting a humidification of the air to correspond to a pressure dew point at a cooling-water outlet temperature;
upon determining that the humidification of the air is no longer sufficient at a predetermined low pressure, increasing an entry pressure to achieve the humidification of the air by a shift in a water-vapor partial pressure curve;
and controlled throttling of the air exit stream.

2. The method according to claim 1, which comprises throttling the air exit stream automatically by associated actuating electronics.

3. The method according to claim 2, which comprises driving the actuating electronics within a central fuel cell operating management.

4. The method according to claim 1, wherein the shift in the water-vapor partial pressure curve is effected to enable the humidification of the air with a lower energy consumption than without the throttling of the air exit stream.

5. The method according to claim 4, which comprises effecting the shift in the water-vapor partial pressure curve to enable smaller quantities of water to be used for sufficient humidification of the air than without the shift in the water-vapor partial pressure curve.

6. A PEM fuel cell system, comprising:
at least one fuel cell module comprising PEM fuel cells;
a first process gas inlet for feeding hydrogen to said fuel cells;
a second process gas inlet for feeding air to said fuel cells;
an outlet side, a throttling member disposed at said outlet side, and actuating electronics connected to said throttling member for adjusting a position of said throttling member;
a device for supplying air to said second process gas inlet and for humidifying the air, said device including a compressor for compressing the air; and
a control device for managing a fuel cell operating process, wherein the position of said throttling member effecting a pressure raising a compression power of said air compressor to a pressure level required for sufficient humidification of the air, with said actuating electronics serving to correct the position of said throttling member.

7. The fuel cell system according to claim 6, wherein said actuating electronics and said throttling member are connected via a bidirectional connection.

8. The fuel cell system according to claim 7, wherein said actuating electronics and said control device for managing the fuel cell operating process are connected via a bidirectional connection.

9. The fuel cell system according to claim 8, wherein said control device for managing the fuel cell operating process includes means for recording actual values of operating variables of the fuel cell system.

10. The fuel cell system according to claim 9, wherein said control device for managing the fuel cell operating process is configured to record an air entry pressure for said fuel cell module.

11. The fuel cell system according to claim 6, wherein said air compressor is a screw-type compressor.

12. The fuel cell system according to claim 6, wherein said throttling member is a controllable throttle valve.

13. The fuel cell system according to claim 6, which further comprises a heat exchanger with cooling medium communicating with said fuel cell module.

14. The fuel cell system according to claim 6, which further comprises a water separator at said outlet side, and an electrically controllable valve for discharging excess water communicating with said water separator.

15. The fuel cell system according to claim 14, wherein said water separator includes a level indicator.
